(19) United States
(12) Patent Application Publication
(10) Pub. No.: US 2016/0246404 A1
(43) Pub. Date: Aug. 25, 2016

(54) TOUCH DISPLAY DEVICE AND FABRICATION METHOD THEREOF

(71) Applicants: BOE TECHOLOGY GROUP CO., LTD., Beijing (CN); CHENGDU BOE OPTOELECTRONICS TECHOLOGY CO., LTD, Chengdu, Sichuan (CN)

(72) Inventors: Junrui ZHANG, Beijing (CN); Junhwan LIM, Beijing (CN)

(21) Appl. No.: 14/437,071

(22) PCT Filed: Aug. 27, 2014
(86) PCT No.: PCT/CN2014/085296

§ 371 Date: Apr. 20, 2015

(30) Foreign Application Priority Data
Mar. 10, 2014 (CN) 201410086450.7

(51) Int. Cl. G06F 3/044; G02F 1/1335; G02F 1/1333

(52) U.S. Cl. CPC G06F 3/044; G02F 1/13338; G02F 1/133528; G02F 1/133504; G02F 1/133308; G06F 2203/04104; G06F 2203/04103; G02F 2001/133331

(57) ABSTRACT

A touch display device and a fabrication method thereof are provided. The touch display device includes a display panel (101) and a cover plate substrate disposed in an overlapping manner, the display panel (101) having a touch electrode pattern (102) provided on a surface thereof facing the cover plate substrate, and scattering particles (106) are provided in a bonding layer (1031) between an upper side of the touch electrode pattern (102) and the cover plate substrate, so that reflected light rays passing through the touch electrode pattern (102) are scattered. The technical solution makes the reflected lights of the touch electrode pattern (102) scattered when passing through the scattering particles (106) in the bonding layer (1031), thereby reducing visibility of a pattern of transparent electrode layer and avoiding influence on display quality; meanwhile, the above described scattering particles can be formed by doping, and compared with a coating process in the prior art, its process is simpler and cheaper.

### TECHNICAL FIELD

Embodiments of the invention relate to a touch display device and a fabrication method thereof.

### BACKGROUND

Currently, a touch technology is more and more widely used in electronic devices of display type such as smart phones, monitors and so on. At present, in order to achieve a multi-touch function, a capacitive touch screen technology is widely used in small and medium-sized devices. According to different structures, the capacitive touch screen can be divided into three types: out-cell, in-cell and on-cell. On cell technology has features such as comfortable touch, easy lightening and thinning, and low cost and so on, and is critically concerned in the industry. The structure of a general on cell touch display device is illustrated in FIG. 1, including a display panel 101 and a cover plate substrate 105.

In FIG. 1, an upper polarizer 103 and a lower polarizer 100 are respectively disposed above and below a liquid crystal display panel 101. The liquid crystal display panel 101 comprises an array substrate 1011, a liquid crystal layer 1012 and a color filter substrate 1013 from bottom to top. A touch electrode pattern 102 is between the array substrate 1011 and the upper polarizer 103, serving as a sensor part of a touch screen, and the cover plate substrate 105 is arranged above the upper polarizer 103. The cover plate substrate 105 and the upper polarizer 103 can be bonded by an OCR layer 104′.

The on cell technology uses a transparent electrode to form an inductive pattern for the touch screen directly on a substrate of the display panel, and then the cover plate substrate 105 will be used. There is a touch electrode on the touch electrode pattern 102, as illustrated in FIG. 2, and the pattern makes a pattern region where the touch electrode is formed and a blank region have different refractive indexes, resulting in that under reflected lights, which are indicated by arrows in FIG. 2, the pattern of touch electrode is visible, which greatly affects the display quality. Thus, it is necessary to blank the pattern of the touch electrode pattern 102, to reduce the visibility of reflection.

Now a way of multi-layer low-reflection film is used to reduce surface reflection of the touch screen. At present, a layer or more layers of films are coated on the touch electrode pattern or the glass cover plate, and through a combination of refractive indexes of different film layers, a structure of low-reflection film can be formed, thereby effectively reducing the surface reflection; but such structure of low-reflection film is only formed by evaporation or other related coating process, which may increase process steps and costs.

### SUMMARY OF THE INVENTION

One of technical problems to be resolved by the present invention is how to overcome a fact that, after the touch electrode of the existing touch display device is patterned, there will be a difference of refractive indexes between the pattern region and the blank region, resulting in that under reflected lights, the touch electrode pattern is visible and the display quality is affected; meanwhile no additional processes or costs are needed.

The present invention provides a touch display device, comprising a display panel and a cover plate substrate disposed in an overlapping manner, the display panel having a touch electrode pattern on a surface thereof facing the cover plate substrate, and scattering particles being provided in a bonding layer between the touch electrode pattern and the cover plate substrate, so that reflected light rays passing through the touch electrode pattern are scattered.

Further, a polarizer is attached to a side of the touch electrode pattern located on the cover plate substrate, the polarizer is bonded to the touch electrode pattern via a first bonding layer, and the scattering particles are provided in the first bonding layer.

Further, a polarizer is attached to the side of the touch electrode pattern located on the cover plate substrate, the polarizer is bonded to the cover plate substrate via a second bonding layer coated on the cover plate substrate, and the scattering particles are provided in the second bonding layer.

Further, the scattering particles are particulates made of inorganic or organic materials.

Further, the inorganic material is at least one of silicon dioxide and titanium dioxide.

Further, the organic materials are one or several of polystyrene, acrylates and polymethyl methacrylatel.

Further, the polarizer comprises a lower protective layer, a polarizing layer, an upper protective layer and a surface processing layer.

Further, the scattering particles have a diameter of 3˜50 μm.

The present invention further provides a fabrication method of a touch display device, comprising:

Providing a display panel and a cover plate substrate;

Forming a touch electrode pattern on a surface of the display panel facing the cover plate substrate;

Arranging scattering particles in a bonding layer between the touch electrode pattern and the cover plate substrate, so that reflected light rays passing through the touch electrode pattern are scattered; and

Overlaying the cover plate substrate on the display panel.

Further, arranging the scattering particles in the bonding layer between the touch electrode pattern and the cover plate substrate includes: attaching a polarizer to a side of the touch electrode pattern located on the cover plate substrate, the polarizer being attached to an upper side of the touch electrode pattern via a first bonding layer, and the scattering particles being doped into the first bonding layer.

Further, arranging the scattering particles in the bonding layer between the upside of the touch electrode pattern and the cover plate substrate includes: attaching a polarizer on a side of the touch electrode pattern located on the cover plate substrate, the polarizer being attached to the cover plate substrate via a second bonding layer coated on the cover plate substrate, and the scattering particles being doped into the second bonding layer.

A touch display device and a fabrication method thereof provided by the above described technical solution can achieve the purpose of an invisible touch electrode pattern, that is, blanking. By using the method of arranging scattering particles in the bonding layer between the touch electrode pattern and the cover plate substrate, the reflected light rays of the touch electrode pattern are scattered when passing through the scattering particles in the bonding layer, which reduces directivity of the reflected lights of the pattern region having the touch screen pattern and the blank region, thereby reducing the visibility of the pattern in the transparent electrode layer and avoiding the influence on the display quality; meanwhile, the above described scattering particles can be formed by doping, and compared with the coating process in the prior art, its process is simpler and cheaper.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is a structural schematic diagram of an existing on cell touch display device;

FIG. 2 is an optical path view of a touch electrode pattern in the existing on cell touch display device;

FIG. 3 is a structural schematic diagram of an upper polarizer in the present invention;

FIG. 4 is an optical path view of a touch electrode pattern in a touch display device provided by a first embodiment of the present invention;

FIG. 5 is an optical path view of a touch electrode pattern in a touch display device provided by a second embodiment of the present invention.

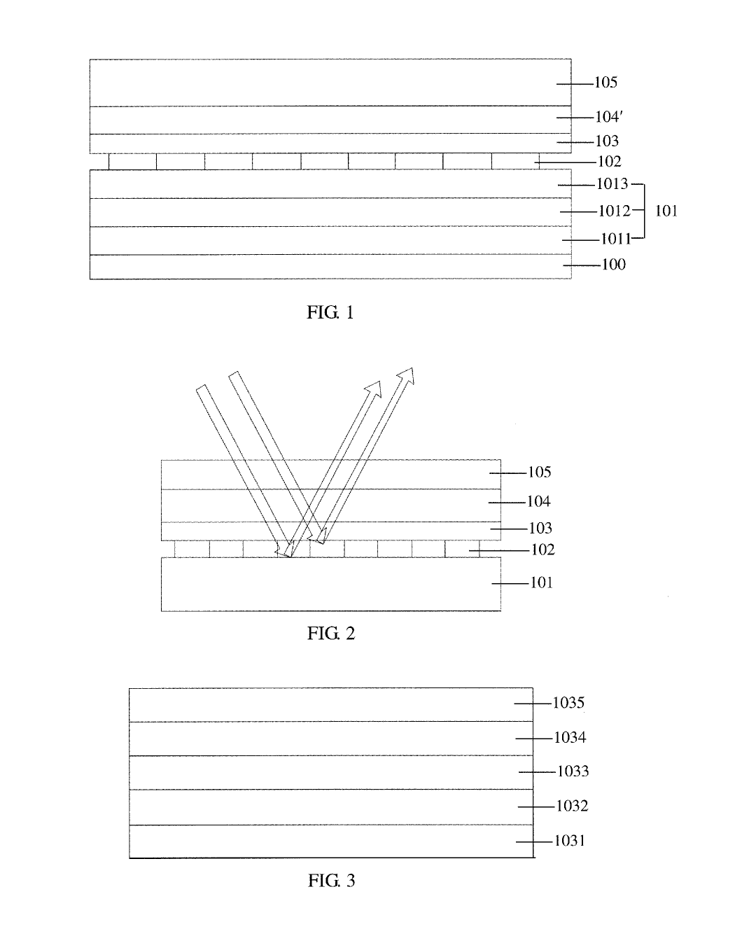

### DESCRIPTION OF THE EMBODIMENTS

In order to make objects, technical details and advantages of the embodiments of the invention apparent, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

In the description of the present invention, it should be noted that, azimuth or positional relationships indicated by terms such as “up”, “down”, “top”, “bottom” and so on, are based on the azimuth or positional relationships illustrated in the drawings, which are only to facilitate description of the invention and simplify the description, but not to indicate or imply that the device or components must have a specific azimuth, or be constructed or operated in the specific azimuth, which thus cannot be understood as a limitation to the invention.

In addition, in the description of the present invention, unless otherwise stated, “a plurality of” refers to two or more.

The present invention provides a touch display device, comprising a display panel and a cover plate substrate disposed in an overlapping manner, the display panel having a touch electrode pattern provided on a surface thereof facing the cover plate substrate. In order to make the reflected lights passing through the touch electrode pattern scattered, scattering particles are provided in a bonding layer between an upper side of the touch electrode pattern and the cover plate substrate, and two embodiments of the present invention are exemplified below for specific illustration. In the embodiments described below, the display panel is a liquid crystal display panel.

### FIRST EMBODIMENT

A touch display device provided by the embodiment, as illustrated in FIG. 4, is to attach a polarizer to an upper side of a touch electrode pattern 102, and the polarizer is an upper polarizer 103 in the whole display device, so the polarizer is called as the upper polarizer 103 hereinafter. The upper polarizer 103 is attached to the upper side of the touch electrode pattern via a first bonding layer 1031, as illustrated in FIG. 4, and scattering particles 106 are provided in the first bonding layer 1031, so that reflected lights passing through the touch electrode pattern 102 are scattered. For example, the first bonding layer 1031 can be a pressure-sensitive adhesive (PSA) layer.

In the embodiment, by arranging the scattering particles 106 in the first bonding layer 1031 between the touch electrode pattern 102 and the upper polarizer 103, a role of scattering lights can be played, and the arrows in FIG. 4 are directions of the optical paths, that is, the surface reflected lights of the touch electrode pattern 102 are scattered when passing through the scattering particles 106 in the first bonding layer 1031, and reduce the directivity of the reflected lights of the pattern region having the touch electrode pattern 102 and blank region, thereby achieving the effect of difficulty in visually distinguishing the two regions, which in turn reduces the visibility of the touch electrode pattern 102. The above described scattering particles 106 can be formed by doping, and as compared with the coating process in the prior art, its process is simpler and cheaper.

The touch electrode pattern 102 can be made from indium tin oxide (ITO) or other transparent conducting materials.

Specifically, as illustrated in FIG. 3, generally the upper polarizer 103 is of a multilayer structure, including a polarizing layer 1033 and an upper protective layer 1034 and a lower protective layer 1032 which are respectively located above and below the polarizing layer 1033; there is a surface processing layer 1035 above the upper protective layer 1034; and the surface processing layer 1035 is bonded with the above cover plate substrate via glue, while the down protective layer 1032 is bonded with the touch electrode pattern 102 via the first bonding layer 1031, so the scattering particles are provided in the first bonding layer 1031 below the upper polarizer 103 (typically PSA), which can reduce the visibility of the pattern of the touch electrode pattern 102 and achieve the purpose of blanking.

The first bonding layer can be contained in the structure of polarizer; that is, as an independent element, the polarizer includes the first bonding layer, while a difference between the embodiment and the existing polarizer is that it is necessary to arrange the scattering particles in the first bonding layer. Of course, the first bonding layer can be arranged independently and not included in the polarizer, which will not be limited by the embodiment.

The scattering particles in the first bonding layer 1031 laying between the touch electrode pattern 102 and the upper polarizer 103 are particulates made of inorganic or organic materials. A diameter of a particulate can be, for example, 3˜50 μm.

The inorganic materials may be silicon dioxide and/or titanium dioxide; and the organic materials are one or several of polystyrene, acrylates and polymethyl methacryl atel.

A fabrication method of a touch control display provided by the embodiment comprises:

Providing a display panel 101 and a cover plate substrate; and forming a touch electrode pattern 102 on a surface of the display panel 101 facing the cover plate substrate, which can be specifically formed by deposition; attaching an upper polarizer to an upper side of the touch electrode pattern 102, the upper polarizer 103 being attached to the upper side of the touch electrode pattern via a first bonding layer 1031, and doping scattering particles 106 in the first bonding layer 1031, to evenly mix the scattering particles 106 and the first bonding layer 1031, so that reflected lights passing through the touch electrode pattern 102 are scattered; and overlaying the cover plate substrate on the display panel.

### SECOND EMBODIMENT

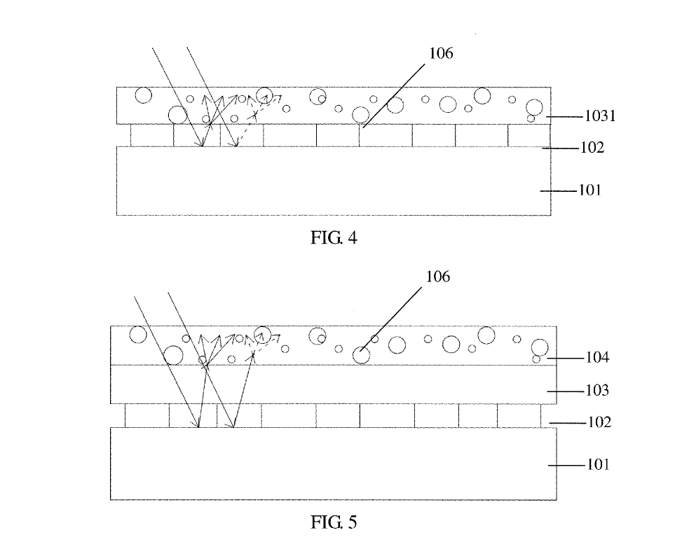

The only difference between this embodiment and the first embodiment is that, as illustrated in FIG. 5, a polarizer 103 is attached to an upper side of a touch electrode pattern 102, and the polarizer 103 is bonded to a cover plate substrate via a second bonding layer 104 coated on the cover plate substrate. Same as the first embodiment, the polarizer is an upper polarizer 103 in the whole display device. Generally, the second bonding layer 104 is an optical clear resin (OCR), in which scattering particles are provided. It should be pointed out that, when the scattering particles 106 are arranged in the second bonding layer 104 between the cover plate substrate and the upper polarizer 103, a surface-to-surface contact gluing structure should be applied to the cover plate substrate and the upper polarizer 103, because a frame gluing structure generates relatively small scattering region, which is limited by the frame and not able to form the scattering of whole screen, and thereby not conducive to reduce the visibility of the pattern of the touch electrode pattern 102.

In the embodiment, the scattering particles 106 arranged in the second bonding layer 104 between the cover plate substrate and the upper polarizer 103, can play a role of scattering lights, and the arrows in FIG. 5 are directions of the optical paths, that is, the surface reflected lights of the touch electrode pattern 102 are scattered when passing through the scattering particles 106 in the second bonding layer 104, and reduce the directivity of the reflected lights of the pattern region having the touch electrode pattern 102 and the blank region, thereby achieving the effect of difficulty in visually distinguishing the two regions, which in turn reduces the visibility of the touch electrode pattern 102 and achieves the purpose of blanking. The above described scattering particles can be formed by doping on the bonding layer, and compared with the coating process in the prior art, its process is simpler and cheaper.

Same as the first embodiment, the scattering particles 106 arranged in the second bonding layer 104 between the cover plate substrate and the upper polarizer 103 are particulates made of inorganic or organic materials. The diameter of a particulate can be, for example, 3˜50 μm.

The inorganic materials may be silicon dioxide and/or titanium dioxide. The organic materials are one or several of polystyrene, acrylates and polymethyl methacrylatel.

A fabrication method of a touch display device provided by the embodiment comprises: providing a display panel 101 and a cover plate substrate; and forming a touch electrode pattern 102 on a surface of the display panel 101 facing the cover plate substrate, which can be specifically formed by deposition; attaching an upper polarizer 103 to an upper side of the touch electrode pattern 102, the upper polarizer 103 being attached to a cover plate substrate via a second bonding layer 104 coated on the cover plate substrate, and doping scattering particles 106 in the second bonding layer 104, to evenly mix the scattering particles 106 in the glue of the second bonding layer 104, so that reflected lights passing through the touch electrode pattern 102 are scattered; and overlaying the cover plate substrate on the display panel.

### THIRD EMBODIMENT

The only difference among this embodiment, the second embodiment and the second embodiment is that, in this embodiment, the scattering particles are arranged simultaneously in the first bonding layer between the touch electrode pattern and the upper polarizer and in the second bonding layer between the cover plate substrate and the upper polarizer, which can further reduce the visibility of the pattern of the touch electrode pattern, achieve the purpose of blanking and improve the display quality.

A fabrication method of a touch display device provided by the embodiment is a combination of the fabrication methods provided by the first embodiment and the second embodiment, which will not be repeated here.

The touch display device and fabrication method thereof provided by the present invention are particularly applicable to an on-cell touch display device, which aims to achieve the purpose of making the pattern of touch electrode pattern invisible, that is, blanking. By using the method of arranging scattering particles in the bonding layer between the upper side of the touch electrode pattern and the cover plate substrate, the reflected lights of the touch electrode pattern are scattered when passing through the scattering particles in the bonding layer, which reduces directivity of the reflected lights of the pattern region having the touch screen pattern and the blank region, thereby reducing the visibility of the pattern in the transparent electrode layer and avoiding the influence on the display quality.

Meanwhile, the above described scattering particles can be formed by doping, and compared with the coating process in the prior art, its process is simpler and cheaper.

The foregoing embodiments merely are exemplary embodiments of the invention, and not intended to define the scope of the invention, and the scope of the invention is determined by the appended claims.

The present application claims priority of Chinese Patent Application No. 201410086450.7 filed on Mar. 10, 2014, the disclosure of which is incorporated herein by reference in its entirety as part of the present application.

1. A touch display device, comprising a display panel and a cover plate substrate disposed in an overlapping manner, the display panel having a touch electrode pattern provided on a surface thereof facing the cover plate substrate, wherein scattering particles are provided in a bonding layer between the touch electrode pattern and the cover plate substrate, so that reflected light rays passing through the touch electrode pattern are scattered.

2. The touch display device according to claim 1, wherein,
a polarizer is attached to a side of the touch electrode pattern located on the cover plate substrate, the polarizer is bonded to the touch electrode pattern via a first bonding layer, and the scattering particles are provided in the first bonding layer.

3. The touch display device according to claim 1, wherein,
a polarizer is attached to a side of the touch electrode pattern located on the cover plate substrate, the polarizer is bonded to the cover plate substrate via a second bonding layer coated on the cover plate substrate, and the scattering particles are provided in the second bonding layer.

4. The touch display device according to claim 1, wherein the scattering particles are particulates made of inorganic or organic materials.

5. The touch display device according to claim 4, wherein the inorganic material is at least one of silicon dioxide and titanium dioxide.

6. The touch display device according to claim 4, wherein the organic materials are one or several of polystyrene, acrylates and polymethyl methacrylatel.

7. The touch display device according to claim 2, wherein the polarizer comprises a lower protective layer, a polarizing layer, an upper protective layer and a surface processing layer.

8. The touch display device according to claim 1, wherein the scattering particles have a diameter of 3˜50 μm.

9. A fabrication method of a touch display device, comprising:
providing a display panel and a cover plate substrate;
forming a touch electrode pattern on a surface of the display panel facing the cover plate substrate;
arranging scattering particles in a bonding layer between the touch electrode pattern and the cover plate substrate, so that reflected light rays passing through the touch electrode pattern are scattered; and
overlaying the cover plate substrate on the display panel.

10. The fabrication method according to claim 9, wherein arranging the scattering particles in the bonding layer between the touch electrode pattern and the cover plate substrate includes: attaching a polarizer to a side of the touch electrode pattern located on the cover plate substrate, the polarizer being attached to an upper side of the touch electrode pattern via a first bonding layer, and the scattering particles being doped into the first bonding layer.

11. The fabrication method according to claim 9, wherein arranging the scattering particles in the bonding layer between the touch electrode pattern and the cover plate substrate includes: attaching a polarizer to a side of the touch electrode pattern located on the cover plate substrate, the polarizer being attached to the cover plate substrate via a second bonding layer coated on the cover plate substrate, and the scattering particles being doped into the second bonding layer.

12. The fabrication method according to claim 9, wherein the scattering particles are particulates made of inorganic or organic materials.

13. The fabrication method according to claim 12, wherein the inorganic material is at least one of silicon dioxide and titanium dioxide.

14. The fabrication method according to claim 12, wherein the organic materials are one or several of polystyrene, acrylates and polymethyl methacrylatel.

15. The touch display device according to claim 2, wherein the scattering particles are particulates made of inorganic or organic materials.

16. The touch display device according to claim 3, wherein the scattering particles are particulates made of inorganic or organic materials.

17. The touch display device according to claim 3, wherein the polarizer comprises a lower protective layer, a polarizing layer, an upper protective layer and a surface processing layer.

18. The touch display device according to claim 2, wherein the scattering particles have a diameter of 3˜50 μm.

19. The fabrication method according to claim 10, wherein the scattering particles are particulates made of inorganic or organic materials.

20. The fabrication method according to claim 11, wherein the scattering particles are particulates made of inorganic or organic materials.
